(19) United States
(12) Patent Application Publication
(10) Pub. No.: US 2007/0136036 A1
(43) Pub. Date: Jun. 14, 2007

(54) Radio frequency identification system deployer

(76) Inventors: Patrick Joseph Sweeney II, Philomont, VA (US); Xiaohang Wang, Reston, VA (US)

Correspondence Address: JUSTIN GRAY, 12003 WALNUT BRANCH RD., RESTON, VA, 20194, US

(21) Appl. No.: 11/164,865

(22) Filed: Dec. 8, 2005

(51) Int. Cl. G06G 7/48

(52) U.S. Cl. 703/6

(57) ABSTRACT

A method and system for deploying radio frequency identification (RFID) systems. The system presents the floor plan of the site to which the RFID system is to be deployed. A user may add representations of RFID interrogators to the site and use information that the system presents to determine ideal location, orientation, power levels and other parameters of an effective and efficient RFID system. An embodiment of the system will then configure and test those settings on the actual interrogators. Site survey information may be entered into the system to facilitate better calibration. The system may be employed within a larger management system for enhanced RFID system performance after deployment.

### BACKGROUND OF INVENTION

Radio frequency identification (RFID) systems allow for the identification of objects at a distance and out of line of sight. They are comprised of transponders called radio frequency identification (RFID) tags and RFID interrogators (also called readers or readers and antennas). The tags are generally smaller and less expensive than interrogators, and are commonly attached to objects such as product cases in warehouses or supply chains and assets to be tracked. When an RFID tag comes within range of an interrogator, it may provide power to the tag via a querying signal, or the RFID tag may use stored power from a battery or capacitor to send a radio frequency signal to be read by the RFID interrogator.

RFID tags may consist of single integrated circuits, circuits and antennas, or may incorporate more complex capabilities such as computation, data storage, and sensing means. Some examples of a few of the various categories of RFID tags include the following: passive tags that acquire power via the electromagnetic field emitted by the interrogator, semi-passive tags that respond similarly, but also use on-board stored power for other functions, active tags that use their own stored power to respond to an interrogator's signal, inductively coupled tags that operate at low frequencies and short distances via a coil antenna, single or dipole antenna-equipped tags that operate at higher frequencies and longer distances, read-write tags that can alter data stored upon them, full-duplex or half duplex tags, collision arbitration tags that may be read in groups, or non-collision tags that must be read individually.

RFID systems generally consist of RFID tags, RFID interrogators and may also include middleware computing devices. Downstream processing of RFID signal information such as EPC numbers, GTINs, or UID numbers usually occurs in two stages. Tag responses are and converted to a standard packet form by the interrogator and sent to the middleware device. The middleware device is responsible for processing the raw information into a useful form. For instance, a reader may send many identical packets when a tag attached to an object moves along a conveyor belt past an interrogator. The numerous identical packets create a form of chatter whereby the interrogator is repeatedly sending identical information. The middleware reduces the chatter of the interrogator to a concise and structured stream of unique packets. These packets are then typically sent to an enterprise application that processes the data. Examples of such applications include those that perform inventory management, supply chain management and analysis, or purchase and backorder handling.

RFID systems present a number of advantages over other object marking and tracking systems. A radio frequency interrogator may be able to read a tag when it is not in line of sight from the interrogator, when the tag is dirty, or when a container encloses the tag. RFID systems may identify objects at greater distances than optical systems, may store information into read/write tags, may operate unattended, and may read tags hidden from visual inspection for security purposes. These advantages make RFID systems useful for tracking objects and as well as making such systems more versatile than bar code or other marking technologies. RFID systems are being adopted for use in retail stores, airports, warehouses, postal facilities, and many other locations. RFID systems will likely be more widely adopted as the price of tags and interrogators decreases.

As organizations strive to adopt RFID systems for tracking objects, they face challenges imposed by the nature of the objects they handle and the environments in which those objects are processed. Radio frequency signals are reflected, refracted, or absorbed by many building, packaging, or object materials. Moving people, vehicles, weather and ambient electromagnetic radiation can also effect the performance of RFID systems. Compounding the situation is a growing diversity of choices among RFID systems and components with dimensions such as cost, range, and power consumption. An RFID tag may deliver varying performance depending upon its orientation and location upon or within a package, its distance from a reader and the frequency at which it operates. An RFID interrogator may experience different read rates based upon the power of its signal, the reader configuration or the interference caused by other interrogators in close proximity. Often companies must purchase and evaluate systems through trial and error, a time-consuming and costly process. Very few firms have the capability to actually conduct effective testing. Consequently, many deployments are installed haphazardly and then, if they fail, comprehensive testing is sometimes done after the fact. Not only does this delay the RFID system deployment, but it also makes it more costly. Experienced teams come at a high price and their testing takes a long time. A need exists for a system that can incorporate RF site survey data and the heuristics generated by successful installations to facilitate efficient, successful deployment of RFID systems.

U.S. Pat. No. 6,665,849 discloses a method and apparatus for simulating physical fields. The apparatus differs from this invention in that it addresses issues of integrated circuit interface. It simulates high frequency effects for the design of on-chip interconnect structures. The apparatus does not facilitate the deployment of whole RFID systems.

U.S. Pat. No. 5,999,861 discloses a method and apparatus for computer-aided design (CAD) of different-sized RF modular hybrid circuits. The apparatus differs from this invention in scale and capability. It designs circuits, rather than configurations of circuits. The apparatus does not simulate RFID system use, nor does it have the capability to configure RF systems.

U.S. Pat. No. 5,339,087 discloses a wavefront simulator that emulates plane wave propagation from multiple transmitting antennas to determine the configuration of antennas or to cancel the energy of an interfering transmitter. The apparatus differs from this invention in that it does not provide an effective mechanism for overlaying RFID system characteristics on a site floor plan and is not specific to configuring actual interrogators.

U.S. Pat. No. 6,346,881 discloses an apparatus for evaluating and installing a wireless system. The apparatus differs from this invention in that it does not present a graphical interface allowing for deployment planning and does not incorporate specifics of RFID systems.

### SUMMARY OF INVENTION

This invention relates to a method and system for deploying and configuring radio frequency identification (RFID) systems. An embodiment of the system comprises a graphical display of the floor plan of a site in which an RFID system is to be deployed, a means for entering site data, and a means for simulating aspects of the RFID system operation. The system allows for the user to enter and display a floor plan and photographic view of the site to which the RFID system is to be deployed. A user may add representations of portals and RFID interrogators to the site and use information that the system presents to determine ideal location, orientation, power levels and other parameters of an effective and efficient RFID system. Site survey information may be entered into the system to facilitate better calibration. An embodiment of the system may use locations and orientations of antennas, specifications of RFID tags, specifications of RFID interrogators, dimensions of walls and doorways and other information pertinent to simulation of aspects of the RFID system. Another embodiment uses one or more antennas and one or more signal measuring devices such as oscilloscopes, spectrum analyzers, and multi-purpose signal measuring devices, connected to one or more RFID tag antennas to enter information into the system.

Another embodiment allows the system to be interfaced with each specific RFID interrogator and create the proper configuration of various parameters (such as power level, duty cycle, etc) and verify those settings via real-time feedback to the software from the interrogator. The system may be employed within a larger management system for enhanced RFID system performance after deployment.

The foregoing general description and the following detailed description are exemplary and explanatory only and do not restrict the claims directed to the invention. The accompanying drawings, which are incorporated in and constitute a part of this specification, illustrate some embodiments of the invention and together with the description, serve to explain the principles of the invention but not limit the claims or concept of the invention.

### BRIEF DESCRIPTION OF DRAWINGS

FIG. 1 is a screen shot of an embodiment of the system.

FIG. 2 is a screen shot of a data entry window in an embodiment of the system.

FIG. 3 is a screen shot of a site floor plan displayed within an embodiment of the system.

FIG. 4 is a screen shot of a site floor plan displayed within an embodiment of the system with an overlay of example information potentially useful in modeling the efficient deployment of an RFID system.

### DETAILED DESCRIPTION

The following detailed description of various example embodiments of this invention and the attached figures are intended to provide a clear description of the invention without limiting its scope.

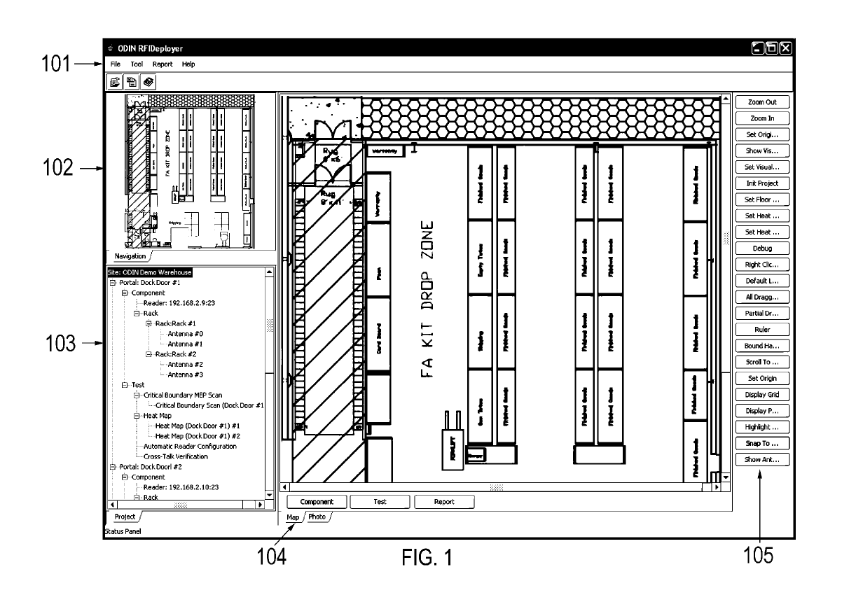

FIG. 1 is a screen shot of an embodiment of the system. Main menu 101 allows the user to select from available modes and operations. Navigation pane 102 shows the entire floor plan of the site the user is currently operating upon. Project pane 103 displays a hierarchical outline of the site, its portals, components within the portals and test results for components. Map pane 104 displays either a blueprint of the selected site's floor plan or the photographic equivalent. Map controls bar 105 presents the actions that a user may take to enter data, navigate the floor plan, simulate aspects of the RFID system or systems operation.

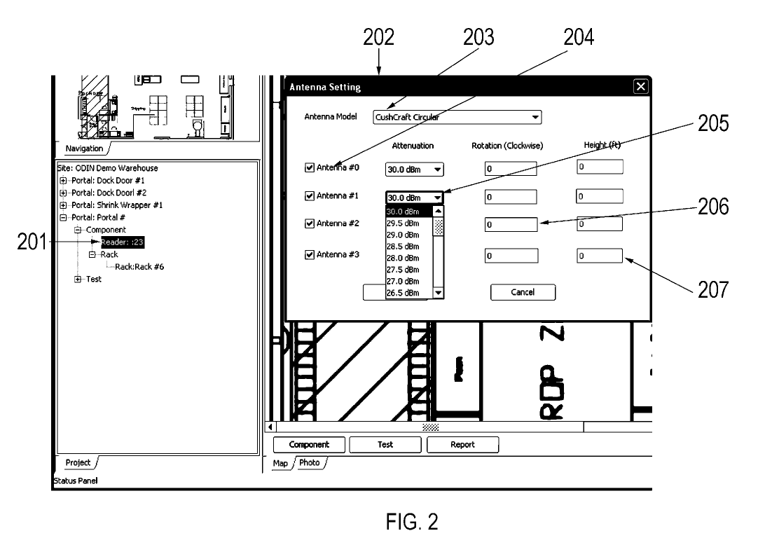

FIG. 2 is a screen shot of a data entry window in an embodiment of the system. Selected item 201 is an RFID interrogator, or “reader,” within a component within a portal within a site labeled “ODIN Demo Warehouse.” Window 202 allows the user to specify the antenna or antennas that are used by the selected item 201. Menu 203 is a pop-up menu that allows the user to select among a variety of makes and models of antennas. In the embodiment as shown, new makes and models may be added to the system via a separate interface. Window 202 supports up to 4 antennas that may be selected by check box 204 and its counterparts. Once an antenna such as the one specified by check box 204 is selected, parameters affecting its performance may also be specified. Attenuation setting pop-up menu 205 allows for rapid selection among a menu of attenuation levels appropriate to the particular antenna. Rotation text entry box 206 allows for a numerical value to be entered for the rotation for the corresponding antenna. Height text box 207 allows the user to specify the height of the antenna from the floor.

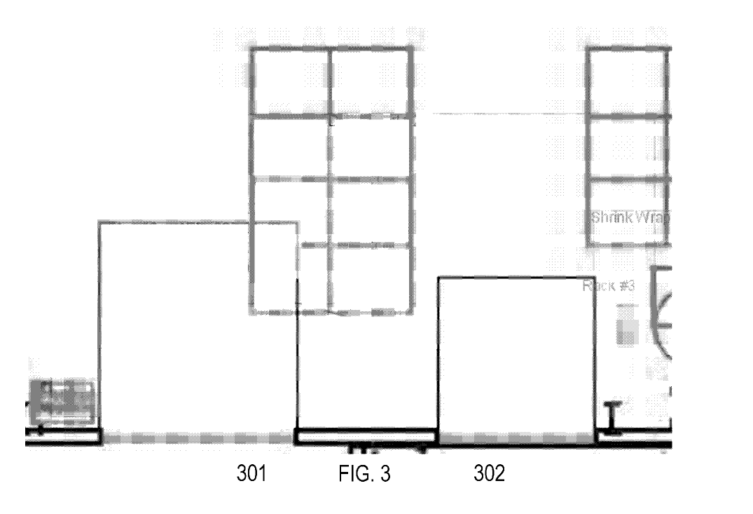

FIG. 3 is a screen shot of a site floor plan displayed within an embodiment of the system. A user of the system may import CAD files or graphic files containing this information. A user may also load corresponding digital photographic files to be displayed within the same map pane 104 of the graphical interface of FIG. 1. Doorways 301 and 302 represent features of a floor plan of particular interest in the deployment of an RFID system. Some categories of such portals include dock doors, conveyors and shrink wrappers. Each of these portals has characteristics that the system uses to facilitate the simulation of aspects of the planned RFID system operation. Once a user has entered floor plan data has into the system, they may set the appropriate scale so that specifications of RFID system components such as tags and antennas may be evaluated against the elements of the floor plan.

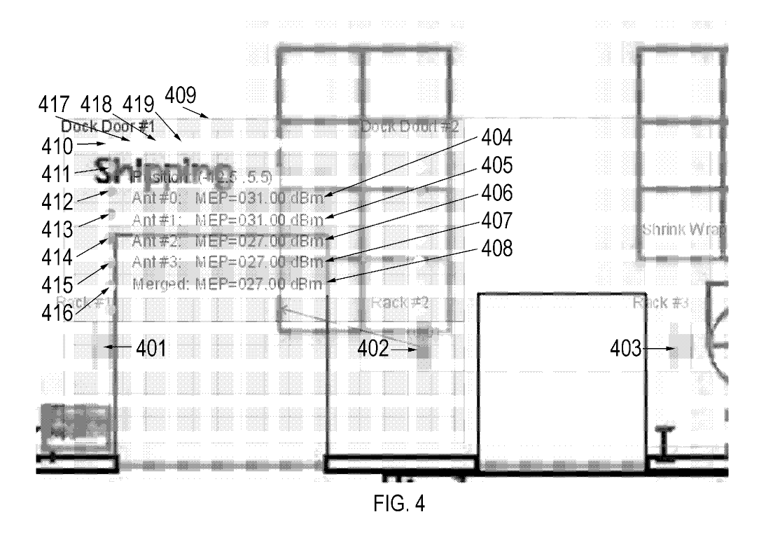

FIG. 4 is a screen shot of a site floor plan displayed within an embodiment of the system with an overlay of information useful in developing an efficient deployment of an RFID system. Racks 401, 402, and 403 are displayed overlaid upon the floor plan. A user of the system may move them upon the unit grid and request an updated report of simulated aspects of the RFID system operation based upon the new location of the racks. A user may specify the characteristics of elements within the racks, such as RFID interrogators or antennas. The embodiment shown displays the minimum effective power levels for antennas 0 through 3 and the merged value for the antennas in overlays 404-408. Heat map circles 409-416 provide a graphical indication of measured signal levels via color, texture, intensity or shape.

What is claimed is:

1. A system for deploying radio frequency identification (RFID) systems comprising: a graphical display of the floor plan of a site in which an RFID system is to be deployed; a means for entering site data; and a means for simulating aspects of the RFID system or systems operation such that a user may enter site data using the means for entering site data, simulate aspects of the RFID system via the means for simulating and view the results upon the graphical display.

2. A system according to claim 1 wherein all of the elements of the system are comprised of software.

3. A system according to claim 1 wherein the site data to be entered includes RFID tag specifications.

4. A system according to claim 1 wherein the site data to be entered includes RFID interrogator specifications.

5. A system according to claim 1 wherein the site data to be entered includes site survey data.

6. A system according to claim 1 wherein the site data to be entered includes dimensions of walls and doorways.

7. A system according to claim 1 wherein the site data to be entered includes locations and orientations of RFID interrogator antennas.

8. A system according to claim 1 wherein the site data to be entered includes information acquired by one or more signal measuring devices selected from the group consisting of oscilloscopes, spectrum analyzers, and multi-purpose signal measuring devices, connected to one or more RFID tag antennas.

9. A system according to claim 1 wherein the aspect of the RFID system or systems operation to be simulated is the power level of radio frequency signals at various locations in a site to which an RFID system is to be deployed.

10. Using a system for deploying radio frequency identification (RFID) systems comprising: a graphical display of the floor plan of a site in which an RFID system is to be deployed; a means for entering site data; and a means for simulating aspects of the RFID system or systems operation, a method comprising: entering site data into the system; simulating aspects of the RFID system or systems operation; and presenting the resulting characteristics of the simulated system by means of the graphical display.

11. A method according to claim 10 wherein some of the data entered into the system is acquired by means of one or more signal measuring devices selected from the group consisting of oscilloscopes, spectrum analyzers, and multi-purpose signal measuring devices, connected to one or more RFID tag antennas.

12. A method according to claim 10 wherein the system configures RFID interrogators of the RFID system.

13. A method according to claim 10 wherein the system configures RFID interrogators of the RFID system to achieve optimal performance.

14. A method according to claim 10 wherein the site data to be entered includes locations and orientations of RFID interrogator antennas.

15. A method according to claim 10 wherein the site data to be entered includes site survey data.

16. A method according to claim 10 wherein the site data to be entered includes dimensions of walls and doorways.

17. A method according to claim 10 wherein the site data to be entered includes locations and orientations of RFID interrogator antennas.

18. A method according to claim 10 wherein the site data to be entered includes information acquired by one or more signal measuring devices selected from the group consisting of oscilloscopes, spectrum analyzers, and multi-purpose signal measuring devices, connected to one or more RFID tag antennas.

19. A method according to claim 10 wherein the aspect of the RFID system or systems operation to be simulated is the power level of radio frequency signals at various locations in a site to which an RFID system is to be deployed.

20. A method according to claim 10 wherein all operations are performed in software.
